(19) United States
(12) Patent Application Publication
(10) Pub. No.: US 2002/0087655 A1
(43) Pub. Date: Jul. 4, 2002

(54) INFORMATION SYSTEM FOR MOBILE USERS

(76) Inventors: THOMAS E. BRIDGMAN, CROTON-ON-HUDSON, NY (US); PAUL BAO-LUO CHOU, MONTVALE, NJ (US); LAWRENCE ISAAC LIEBERMAN, SCARSDALE, NY (US); TE-KAI LIU, ELMSFORD, NY (US); BRUCE DAVID LUCAS, YORKTOWN HEIGHTS, NY (US); RAKESH MOHAN, STAMFORD, CT (US); PAUL ANDREW MOSKOWITZ, YORKTOWN HEIGHTS, NY (US); JUNG-MU TANG, SOUTH SALEM, NY (US)

Correspondence Address: MCGINN & GIBB, PLLC, 8321 OLD COURTHOUSE ROAD, SUITE 200, VIENNA, VA, 22182-3817, US

(21) Appl. No.: 09/311,277

(22) Filed: May 14, 1999

Related U.S. Application Data
(60) Provisional application No. 60/117,595, filed on Jan. 27, 1999.

(51) Int. Cl. G06F 15/16

(52) U.S. Cl. 709/217; 709/247

(57) ABSTRACT

An information system for a mobile user, includes a source of content information, a proxy server for accessing the source of content information, a wireless communications link coupled to the proxy server, and a mobile computing system coupled to the proxy server via the wireless communication link

### CROSS-REFERENCE TO RELATED APPLICATIONS

The present application is related to U.S. patent application Ser. No. 09/235,793, filed on Jan. 22, 1999, to C.-S. Li et al., entitled “DATA REPRESENTATION SCHEMA TRANSLATION THROUGH SHARED EXAMPLES”, and having IBM Docket No. YO998-407, assigned to the present assignee, and incorporated herein by reference, and to U.S. Provisional Patent Application No. 60/117,595, to S. de Gennaro et al., entitled “CONVERSATIONAL BROWSER AND VIRTUAL MACHINE”, filed on Jan. 28, 1999, and having IBM Docket No. YO999-033, incorporated herein by reference.

### BACKGROUND OF THE INVENTION

1. Field of the Invention

The present invention generally relates to an information system, and more particularly to an information system for mobile users.

2. Description of the Related Art

In today's society, people use their automobile for most of their travel requirements including traveling to their workplace, running errands, traveling on vacation, etc. Such travel is very time-consuming and typically the vehicle occupants (and especially the vehicle operator) are unable to perform any meaningful, substantive activities. At most, the vehicle operator can operate a portable phone, listen to an audio program, or converse with other vehicle occupants. Thus, much valuable time is lost.

Further, employees typically live a relatively great distance away from the workplace, thereby requiring a great deal of commuting time in an automobile or the like. Other employees are required by their jobs to spend large amounts of time on the road. As a result, many productive hours per week are lost by such time spent in a car in that the employees may not be able to work in a computing environment and/or have access to computing resources other than a stand-alone laptop computer. Thus, there is a great need for the mobile user to receive and process information which would allow increased computing and communications.

The driver or passenger in a motor vehicle, e.g. car, truck, etc., is isolated from the usual means of computer access. Personal productivity is reduced because of the isolation from productivity tools such as e-mail, calendar and address book. Timely information that may normally be obtained over the Internet on subjects such as stock prices, sports scores, filtered news, and worldwide weather information is generally unavailable. Access to map databases and updated navigation information is limited.

It might be imagined that the above problems could be solved by placing a personal computer in the car. However, the automotive environment differs in several significant ways from a personal computer (PC) desktop work environment. To provide information to a consumer in a moving vehicle and to provide an “end-to-end solution”, issues raised by the network connection used and the unique user interface requirements for the vehicle driver must be addressed.

For example, when the vehicle is in motion, the automotive client computer can only be connected by a wireless link. However, using a standard cellular phone voice link is a slow way to communicate information because of the nature of the human voice. It takes over one minute for a person to speak the equivalent of about one-half page of text. This is 1 KByte (8 Kbits) of data. Also, establishing a voice link to transmit text requires the link to be maintained for the length of the data exchange. There are periods when the link is broken or no wireless link can be established because the vehicle is out of range of its wireless service provider or because the communications path is obstructed (e.g., by natural or man-made obstacles). Thus, sending speech over a slow intermittent wireless link is a problem.

Moreover, a significant demand is placed on the user interface requirements for a moving vehicle. As mentioned above, most vehicle use occurs when a single person (e.g., the driver) commutes to and from work. The use of a computer keyboard, mouse, or standard display is impossible. The driver must be free to operate the vehicle safely.

Further, it is noted that conventional systems exist which have attempted to provide a solution to the above and other problems by using either server-based solutions or client-based solutions. An example of a server-based solution is General Magic's Portico®. For this system, the user is connected to a server through a phone or cell-phone link. This is an Interactive Voice Response (IVR) system. However, this system is problematic for mobile use because the intermittent nature of the wireless link prevents adequate communications/computing for applications that require a continuous connection. Further, the cost of such a link is prohibitive.

An example of a client-based solution is the Philips CARiN® navigation system where all of the processing is done on the client device. However, this system is problematic in that the user typically must update the software files on a periodic basis, so that the user is accessing the most current set of navigation aids (e.g., maps).

### SUMMARY OF THE INVENTION

In view of the foregoing and other problems of the conventional methods and structures, an object of the present invention is to provide a method and structure in which the present invention employs a voice interface using voice recognition input and speech synthesis output that allows the driver to access information by conversing with the auto client device while continuing to operate the vehicle without recourse to normally used computer interface means: keyboard, mouse, etc. The driver's eyes and hands are free to allow him to drive the vehicle.

With the invention, speech is transformed into digital text data at the client side and transmitted over a data link. By such processing, the invention achieves a compression of two orders of magnitude over that of using a direct speech link to a server. The 9.2 Kbits of digitized text that may be sent over a cellular digitized packet data (CDPD) link in one second would take one minute or more to send as voice, as in the conventional systems and methods. Thus the invention provides some local computing capability (e.g., at the mobile client) but at the same time takes advantage of the power of server-based computing without the need for having a continuous connection to the server.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 illustrates an implementation of an information system for mobile users according to the present invention;

FIG. 2 illustrates a preferred client architecture according to the present invention;

FIG. 3 illustrates an example of a push-based news service in an application of the system of the present invention; and

FIG. 4 illustrates a wireless Domino® access for a speech markup language according to the present invention.

### DETAILED DESCRIPTION OF PREFERRED EMBODIMENTS OF THE INVENTION

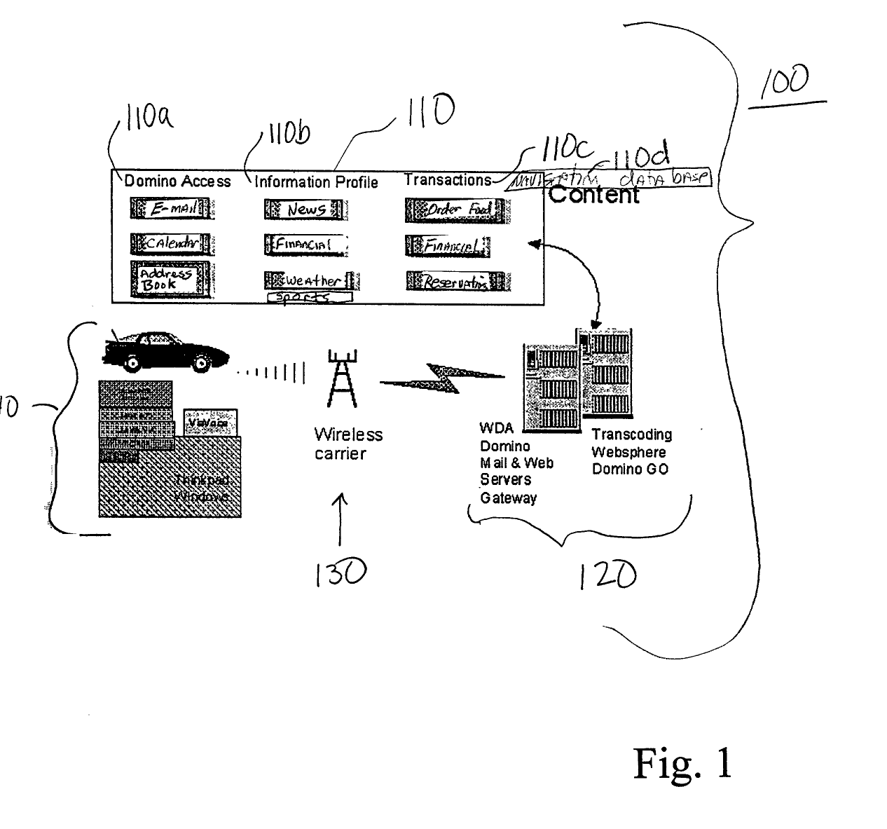

Referring now to the drawings, and more particularly to FIGS. 1-4, there are shown preferred embodiments of the method and structures according to the present invention. For consistency and ease of understanding, the same reference numerals are used throughout the drawings to designate like elements.

As mentioned above, the present invention employs a voice interface using speech recognition input and speech synthesis output that allows the driver to access information by conversing with the mobile client device while continuing to operate the vehicle.

With the invention, by processing the speech input (e.g., transforming speech into digital data using speech recognition) and synthesizing the speech output at the client side, and by using a data communication link, the invention achieves a reduction of the communication bandwidth requirement by two orders of magnitude over that of using a voice communication link between the client and a server. As mentioned above, 9.2 Kbits of text that may be sent over a CDPD link in one second. Such text/data would take one minute or more to send as voice data, as in the conventional systems and methods. Thus, the invention provides a significant processing capability which allows mobile clients such as vehicle operators, users of handheld equipment, etc. to efficiently use their travel time.

FIG. 1 illustrates an information system 100 for mobile users. The system 100 includes a source of content information 110, a proxy server 120, a wireless communications device/link 130, and a mobile client 140.

One source of content 110 could be a Lotus Domino server 110a containing, for example, Lotus Notes based e-mail, calendar, and address book information.

Other forms of content include news, financial quotes, weather, sports news, etc. encoded, for example, in Hypertext Markup Language (HTML) or a markup language conforming to the Extensible Markup Language (XML) standard, delivered according to a user's information profile 110b.

Such content is transcoded, using, for example, the method as disclosed in the above-mentioned commonly-assigned U.S. patent application Ser. No. 09/235,793, filed on Jan. 22, 1999, entitled “Data Representation Schema Translation Through Shared Examples”, and having IBM Docket No. YO998-407, incorporated herein by reference, for example, in the inventive system to present the content in a speech markup language format.

An example of a speech markup language (e.g., IBM's speech markup language) is further described in commonly-assigned U.S. Provisional Patent Application No. 60/117,595, filed on Jan. 28, 1999, entitled “Conversational Browser and Virtual Machine”, and having IBM Docket No. YO999-033, incorporated herein by reference.

Content may be written in a structured markup language that conforms to the Extensible Markup Language (XML) specification to simplify transcoding. For purposes of this application, an XML application is defined as a specific implementation of XML, as described in a Document Type Definition (DTD) or set of DTDs, which is designed to serve a specific purpose.

Other forms of content may include the capability to perform transactions 110c with commercial entities such as hotel reservations, food ordering, financial transactions, and the like. Content may also be in the form of a database for navigation applications 110d (e.g., route planning or location-specific services as provided for example by Global Positioning System (GPS) and the like).

The invention also includes a proxy server 120, as shown in FIG. 1. The server transforms web-based content into, for example, an XML-compliant markup language such as IBM's speech markup language. A gateway, such as the IBM eNetwork™ Wireless Gateway, is used as a part of the server to facilitate communications.

The IBM eNetwork™ Wireless Gateway integrates the leading international packet radio, analog and digital cellular, and wireline networks with a single industry standard interface: TCP/IP. This growing list of supported protocols includes:

DataTac™ (a packet data cellular network defined by Motorola)

DataTac™ Private Mobile Radio (a private DataTac™ network)

Dataradio™ (a wireless packet-switched network technology operated on the VHF and UHF bands)

Mobitex^{SM} (a packet data cellular network defined by Ericsson)

AMPS (Advanced Mobile Phone System)

CDPD (Cellular Digital Packet Data)

GSM (Global System for Mobile Telecommunication)

PCS 1900 (Personal Communication Services, a variation of GSM)

PDC and PHS (Japan)

PSTN (Public Switch Telephone Network)

American digital cellular standards such as TDMA (IS-54), CDMA (IS-95), and iDEN™ data may be supported at a later date.

The Gateway provides a comprehensive, security-rich network access solution. Authentication assures the identity of the mobile user and the gateway to prevent unauthorized access. To provide for data privacy and protection from eavesdropping, the Gateway encrypts all data between the mobile user and the Gateway. Other features such as data reduction, connection management, and packet filtering can be provided by the Gateway.

Regarding the system's wireless communications link 130, the available choices are DataTac™, DataTac™ Private Mobile Radio, Mobitex^{SM}, AMPS, CDPD, GSM, PCS 1900, PDC, and PHS. Generally, there is good CDPD coverage in most populated areas. CDPD runs on standard AMPS circuit-switched analog cellular phone service. Currently, AT&T Wireless®, Bell Atlantic, and GTE all provide CDPD services and may be employed as the carrier.

Further, other means of digital data transmission may be used, as mentioned above. Digital data may also be transmitted over an analog line such as AMPS connection, but at a slower rate.

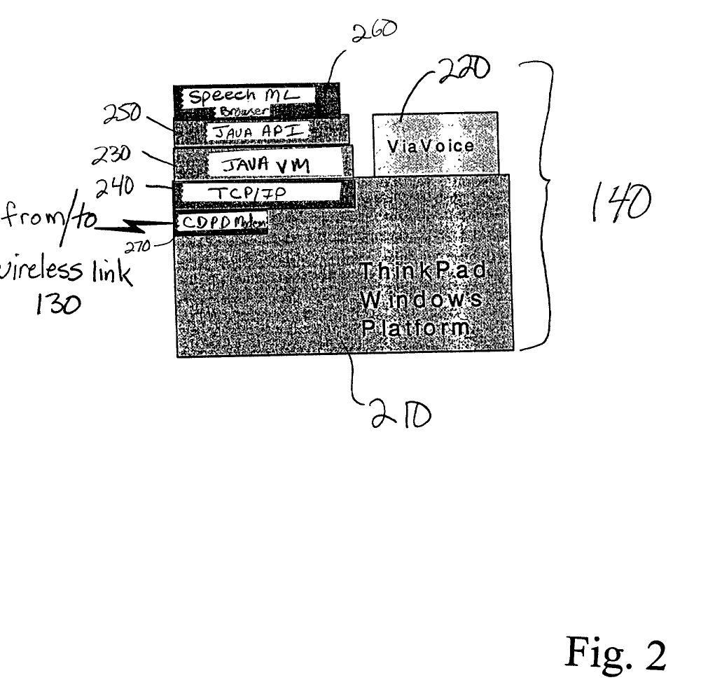

The system of the present invention is designed for use with a mobile client 140. Turning to FIG. 2 which illustrates an exemplary client architecture 140, the exemplary mobile client 140 includes a ThinkPad® Windows® platform 210 on which a voice recognition software system (e.g., IBM's ViaVoice®) 220 may be used to provide both voice recognition and speech synthesis output. A Java® Virtual Machine (JVM) 230 is used with a Transmission Control Protocol/Internet Protocol (TCP/IP) module 240, a Java Application Program Interface (API) 250, and a speech markup language browser 260. The exemplary mobile client device communicates with the server 120 by means of a CDPD modem 270. As an alternative to the above system, the platform 210 may be a real-time operating system (RTOS) running on an embedded device.

As mentioned above, it is noted that conventional methods have attempted to provide solutions to the problem using either server-based solutions or client-based solutions. In contrast to the conventional methods, the invention provides a hybrid in which processing can be performed at both the server and the client.

An example of a server-based solution is General Magic's Portico. For this system, the user is connected to a server through a phone or cell-phone link. Once again, the present invention is advantageous over this system by not requiring that all of the processing be performed at the server. Indeed, the invention provides for local processing as well as taking advantage of processing performed at the server. Moreover, data can be transmitted to the client in advance of any specific request in anticipation that the user will ask for it. Such prefetched data could include personal data, such as the user's e-mail, or data that the user has previously indicated to be of interest via a profile, such as certain stock prices. By keeping current copies of the data on the client (e.g., in a cache or the like), the user is less affected by the intermittent nature of the wireless link. Additionally, since some processing can be performed locally, the cost of the present invention is not as high as a system where all of the processing must be performed at the server. Thus, the cost of the present invention is not as high, nor is the invention as affected by the intermittent nature of the wireless link.

The above-mentioned Philips CARiN® navigation system, which is a client-based solution, is problematic in that all of the processing is done on the client device. In contrast, with the invention, the user needs not update information on a periodic basis, but instead always has access to the most current information.

Exemplary applications demonstrated include personalized news service and Lotus Notes® applications. In an exemplary implementation, the invention built on IBM's Wireless Domino Access® product to provide access to Lotus Notes® databases for e-mail, calendar, address book, and the like.

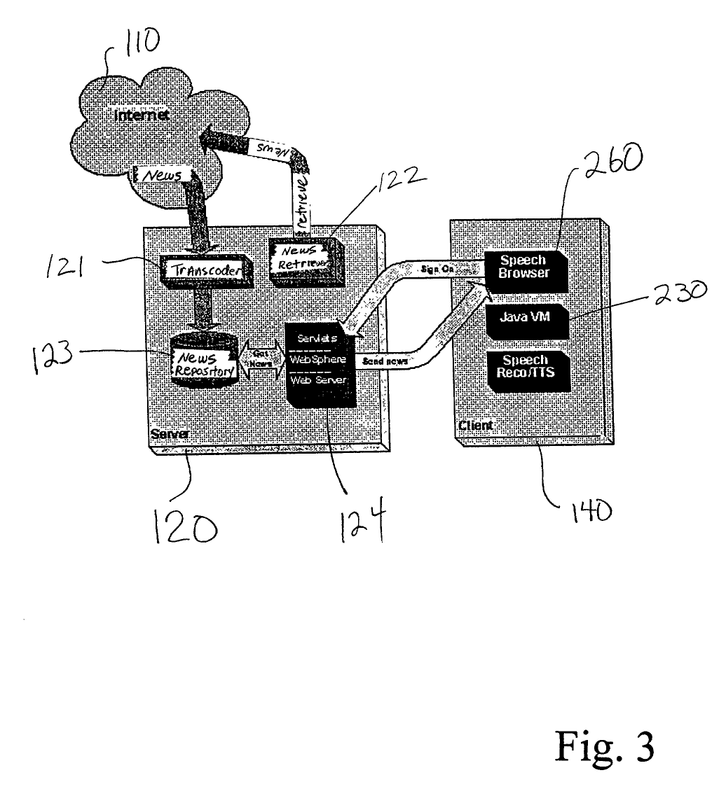

In the News example implementation, as shown in FIG. 3, which illustrates a push-based news service, as part of a personalized information service, a News Service system includes information retrieval from the Internet, content transcoding, and the various (e.g., IBM) server technologies. That is, the server includes a mechanism for transcoding 121, a news retriever 122, a news repository 122 coupled to the transcoding mechanism 121, and an interface module 124 interfacing with the client 140 and including servlets, IBM's WebSphere®, and web server.

The client 140 may employ a speech browser (e.g., browser 260 described above in relation to FIG. 2) which can render IBM's speech markup language. The inventive system has (1) delivered live news from the Internet, (2) used Java Servlet technology based on IBM's WebSphere®, (3) validated the speech markup language capabilities, and (4) explored a transcoding technology to convert a HTML documents to the speech markup language format. The client device 140, a ThinkPad or other computing device, may also include storage means such as disk drives or electronic memory.

With a weakly- or intermittently-connected wireless environment (e.g., a diminished signal power level or lost connection which prevents communications such as can occur near a man-made or natural barrier such as a mountain or in a tunnel), it is important to ensure that the user can always get the latest news whenever he or she is connected. Information can be retrieved based on either a pull model or a push model.

A pull model requires the user's initiative and the information is processed on demand. Such a pull model is good for users who have less time pressure than automotive users and are only interested in getting information when needed.

In contrast, a push model provides a way to get information to the user automatically without any user action. It also has the benefit of processing the same information once for all users. Hence, the latest information is always ready for any user who wants to access it. This is extremely important for automotive users in a weakly- or intermittently-connected environment. Thus, a push-based service (e.g., news service) is advantageous for use with the present invention. The information can be stored in the client device in anticipation of a user request.

As shown in FIG. 2, on the client 140 side, a speech browser 260 is running on a Java Virtual Machine 230 and IBM's speech (e.g., ViaVoice®) technology is used as a user interface.

On the server 120 side, there is a news retriever agent 122 that periodically goes to the Internet to retrieve the latest news from predefined news web sites (e.g., CNN^{SM}, CBS™, CNBC^{SM}, AP^{SM}, Reuters™, etc.). The schedule can be configured for each site according to its updating frequency. The news retrieved from the Internet is typically an HTML document which will be translated to a speech markup language format using a transcoding technology in the transcoder 121, since the speech browser client renders the content in the speech markup language.

The transcoder 121 parses the HTML document into a tree and computes the paths to each text content node. It then uses a translator table to map the paths in the news HTML document to corresponding paths in a speech markup language document. The translation table has been previously generated by supplying examples of the news as both HTML documents and speech markup language documents. Finally, based on these paths, the transcoder generates a document in speech markup language containing the news. This news, in the form of a speech markup language document, is stored in the news repository 123 on a web server waiting to serve users.

Java servlets can be used to handle different server tasks. A “servlet” is an applet running on the server instead of the client. An “applet” is a program designed to be executed from within another program; it can not be executed directly. Here, by “Java servlet” we mean a server-side extension to the web server written in Java. IBM's WebSphere Application Server® can be used on top of any web server to provide a good servlet environment. For example, SignOnServlet is used to handle the user authentication process and GetNewsServlet is used to return a news page to the user based on his or her personal preference.

It is noted that servlet technology via WebSphere is an easy way to add new services, and that information from the Internet preferably is transcoded in a push mode and stored on a web server for better performance. Further, the present inventors have found that the speech browser provides a good hands-free and eyes-free user interface, and that speech markup language supports a plurality of news scenarios.

By hands-free we mean that the driver of the vehicle does not use the usual means for computer data entry (keyboard and mouse), but is free to use his hands on the steering wheel or control knobs on the dashboard of the vehicle. Since the substantial part of the person-computer interaction is accomplished by means of voice recognition and speech synthesis, the driver is free to keep his eyes directed at the road or the instrument displays in the vehicle, thus enabling eyes-free use of the system.

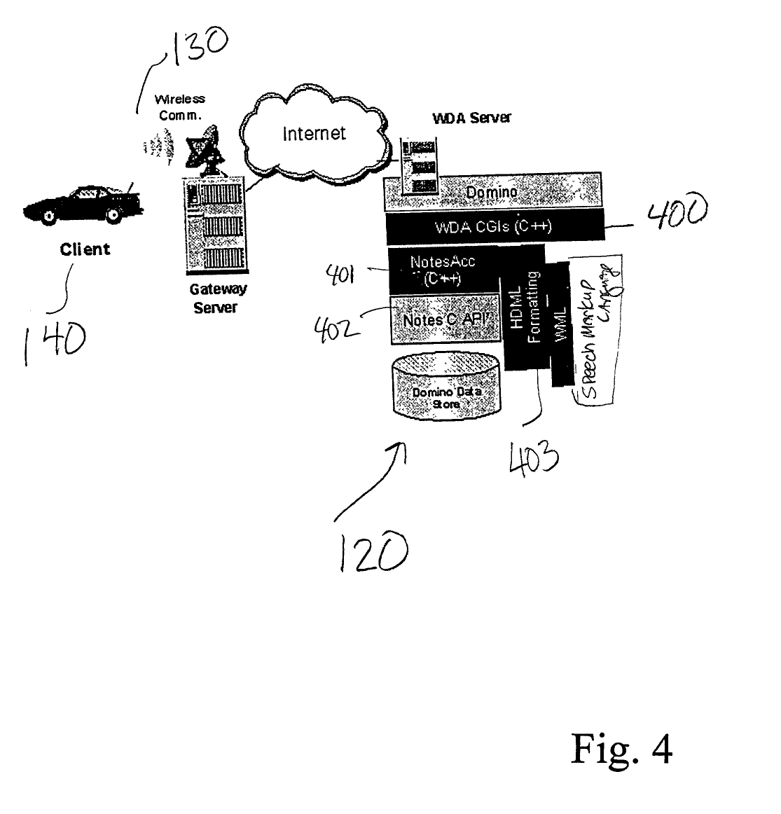

In a second exemplary application, Lotus Notes® content is accessed from the client. FIG. 4 illustrates a Wireless Domino Access® (WDA®) server for IBM's speech markup language. The WDA server may be incorporated into the proxy server 120 of FIG. 1, or may be a separate system which is accessed by the proxy. WDA (also referred to as “Mobile Services for Domino”) consists of a suite of programs which enable access to data residing in selected Lotus Domino® databases from platforms where it would be difficult to implement a full Lotus Notes client, such as on a smart phone or a wireless-enabled personal digital assistant (PDA).

Specifically, it is currently implemented as a set of Common Gateway Interface (CGI) programs 400 designed to run on a Lotus Domino server, each program being capable of rendering specific Domino content in a specific target markup language. In the case of the exemplary application, the output is formatted in IBM's speech markup language. Each WDA program makes use of a Lotus Notes Access Library 401, a set of C++ classes providing an object-oriented wrapper to the Lotus Notes C API 402, as well as a formatting library 403 specialized for the target markup language.

Each formatting library is also a set of C++ classes which simplify the construction and manipulation of a markup document. By using the library, the CGI program is freed from dealing with specific markup syntax, making the program easier to develop and maintain.

While the invention has been described in terms of several preferred embodiments and implementations, those skilled in the art will recognize that the invention can be practiced with modification within the spirit and scope of the appended claims.

For example, besides news services and personal databases, a navigation program can be implemented with the present invention.

Additionally, while the mobile client (mobile computing device) has been described above primarily in regard to a motor vehicle, the mobile client may be any of a ship/boat, an airplane, a train, a handheld unit carried by a user, etc.

What is claimed is:

1. An information system for a mobile user, comprising:
a source of content information;
a proxy server for accessing said source of content information;
a wireless communications link coupled to said proxy server; and
a mobile computing system coupled to said proxy server via said wireless communication link.

2. The system according to claim 1, wherein said source of content information includes at least one of news, financial quotes, sports news, and weather information.

3. The system according to claim 1, wherein said source of content information includes information required for transcoding said information, to present the content to the mobile computing system in a speech markup language format.

4. The system according to claim 1, wherein said source of content information includes content information written in a structured markup language.

5. The system according to claim 1, wherein said source of content information includes transactional information.

6. The system according to claim 1, wherein said source of content information includes a database for a navigation application.

7. The system according to claim 1, wherein said proxy server receives web-based content that can be transcoded into a markup language including a speech markup language, and
wherein said server further includes a gateway for communications, said gateway supporting a plurality of wireless communication protocols and including means for data encryption.

8. The system according to claim 1, wherein said wireless communication link comprises a cellular digitized packet data (CDPD) system.

9. The system according to claim 1, wherein said wireless communication link comprises a digital data transmission system.

10. The system according to claim 9, wherein said digital data transmission system operates on one of DataTac™, DataTac™ Private Mobile Radio, Mobitex^{SM}, AMPS, CDPD, GSM, PCS 1900, PDC, PHS, IS-54 TDMA, IS-95 CDMA, and iDEN™.

11. The system according to claim 1, wherein said mobile computing system includes a Windows platform.

12. The system according to claim 1, wherein said mobile computing system includes a voice recognition system.

13. The system according to claim 1, wherein said mobile computing system includes a Java® Virtual Machine (JVM), a Transmission Control Protocol/Internet Protocol (TCP/IP) module, a Java® Speech API, and a speech markup language browser.

14. The system according to claim 1, wherein said mobile computing system includes a speech synthesis system.

15. The system according to claim 1, wherein said server is connected to the Internet, such that said mobile computing system is connected to the Internet, the server including Wireless Domino Access (WDA) for providing said mobile computing system with access to databases stored on said server.

16. The system according to claim 1, wherein said server is connected to information sources residing on a network, such that said mobile computing system is connected to the information sources through said server.

17. The system according to claim 16, wherein said information sources include a news service system.

18. The system according to claim 17, wherein said new service system comprises one of a push-based news service system and a pull-based news service system.

19. The system according to claim 17, wherein said news service system includes information retrieval from the Internet, and content transcoding.

20. The system according to claim 19, wherein said mobile computing system includes a speech browser for rendering a speech markup language,
said server including means for delivering live news from the Internet to said mobile computing system, and
means for transcoding said news from the Internet and forwarding transcoded information to said mobile communication system so as to convert a Hypertext Markup Language (HTML) document to a speech markup language format.

21. The system according to claim 18, wherein said pull-based news service system processes information on demand.

22. The system according to claim 18, wherein said push-based news service system processes and delivers information to the mobile communication system automatically without any user action, and processes the same information once for all users in said system.

23. The system according to claim 16, wherein said mobile computing system includes a speech browser as a user interface, and
wherein said server includes a news retriever agent that accesses the Internet at predetermined times to retrieve the latest news from news web sites, and
wherein said news retrieved from the Internet is transcoded to a speech markup language format, and said news having been transcoded is stored in a news repository on said server.

24. The system according to claim 23, wherein said server includes a user authentication mechanism and means for returning a news page to the user based on the user's earlier defined preferences.

25. The system according to claim 15, wherein said WDA is implemented as a set of server applications, each for rendering content in a specific markup language,
wherein said WDA uses a specialized library including a set of object-oriented classes and a specialized formatting library for the target markup language, said formatting library also comprising a set of classes for simplifying the construction and manipulation of a markup document.

26. The system according to claim 15, wherein said WDA is implemented as a set of common gateway interface (CGI) scripts, each for rendering specific Domino content in a specific markup language,
wherein said WDA uses a specialized library including a set of object-oriented classes and a specialized formatting library for the target markup language, said formatting library also comprising a set of classes for simplifying the construction and manipulation of a markup document.

27. The system according to claim 1, wherein said mobile computing device is housed within an automobile.

28. The system according to claim 1, wherein said mobile computing device is hand-held by a user.

29. The system according to claim 1, wherein said mobile computing device is carried within one of an airplane, a boat, a train, and a motor vehicle.

30. The system according to claim 1, wherein said content information is in a speech markup language format.

31. The system according to claim 1, wherein said wireless communication link comprises a transmission system in which data is transmitted as digitized text.

32. A hands-free information system for a mobile user, comprising:
a source of content information;
a proxy server for accessing said source of content information;
a wireless communications link coupled to said proxy server; and
a mobile computing system coupled to said proxy server via said wireless communication link.

33. An eyes-free information system for a mobile user, comprising:
a source of content information;
a proxy server for accessing said source of content information;
a wireless communications link coupled to said proxy server; and
a mobile computing system coupled to said proxy server via said wireless communication link.

34. An eyes-free and hands-free information system for a mobile user, comprising:
a source of content information;
a proxy server for accessing said source of content information;
a wireless communications link coupled to said proxy server; and
a mobile computing system coupled to said proxy server via said wireless communication link.

35. The system according to claim 1, wherein said mobile computing system includes a data storage.

36. The system according to claim 1, wherein said mobile computing system includes a real-time operating system (RTOS).

37. The system according to claim 4, wherein said structured markup language is an application of Extensible Markup Language (XML).
